(19) United States
(12) Patent Application Publication
(10) Pub. No.: US 2026/0039958 A1
(43) Pub. Date: Feb. 5, 2026

(54) CONTROL APPARATUS, IMAGE PICKUP APPARATUS, LENS APPARATUS, AND STORAGE MEDIUM

(71) Applicant: CANON KABUSHIKI KAISHA, Tokyo (JP)

(72) Inventor: TOMOMI MOGAMI, Kanagawa (JP)

(21) Appl. No.: 19/277,847

(22) Filed: Jul. 23, 2025

(30) Foreign Application Priority Data
Aug. 5, 2024 (JP) 2024-128744

(51) Int. Cl. H04N 23/68

(52) U.S. Cl. CPC H04N 23/687; H04N 23/6845

(57) ABSTRACT

A control apparatus is configured to control a first image stabilizing operation for reducing a shake at a first frequency of an object image to be imaged and a second image stabilizing operation for reducing a shake at a second frequency higher than the first frequency of the object image. The control apparatus includes one or more memories storing instructions, and one or more processors that, upon execution of the instructions, operate to cause the first image stabilizing operation to be performed before imaging, and cause the second image stabilizing operation to be performed during imaging.

### BACKGROUND

### Field of the Technology

The present disclosure relates to image stabilizing control for imaging.

### Description of the Related Art

Some image pickup apparatuses perform sensor image stabilization (sensor IS), which moves an image sensor to reduce (corrects) image blur caused by camera shake such as hand shake. Japanese Patent Laid-Open No. 2017-021250 discloses, in addition to the sensor IS, an image pickup apparatus that performs image combination image-stabilization (image-combination IS, which is also referred to as image combination and stabilization), which generates a combined image with reduced image blur by aligning and superimposing (combining) a plurality of images acquired by imaging.

In the image combination IS, the image quality of each of the plurality of images to be combined is important. Since the imaging (exposure) time when each image is acquired is short and each image includes fine image blur at high frequencies, such fine image blur at high frequencies may be satisfactorily corrected. Correcting fine image blur at high frequencies during imaging is effective for generation of both a combined image and a single image.

### SUMMARY

A control apparatus according to one aspect of the present disclosure may be configured to control a first image stabilizing operation for reducing a shake at a first frequency of an object image to be imaged and a second image stabilizing operation for reducing a shake at a second frequency higher than the first frequency of the object image. The control apparatus may include one or more memories storing instructions, and one or more processors that, upon execution of the instructions, operate to cause the first image stabilizing operation to be performed before imaging, and cause the second image stabilizing operation to be performed during imaging. An image pickup apparatus and a lens apparatus having the above control apparatus also constitutes another aspect of the present disclosure. A control method corresponding to the above control apparatus also constitutes another aspect of the present disclosure. A storage medium storing a program that causes a computer to execute the above control method also constitutes another aspect of the present disclosure.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are a sectional view and a block diagram of an imaging system according to this embodiment.

FIG. 2 is an exploded perspective view of a sensor IS mechanism according to this embodiment.

FIGS. 3A and 3B are a flowchart illustrating the image stabilizing processing performed in this embodiment.

FIG. 4 is another flowchart illustrating the image stabilizing processing performed in this embodiment.

FIGS. 5A, 5B, and 5C illustrate examples of a lens image stabilization (lens IS) mechanism and a sensor IS mechanism provided to an imaging system according to this embodiment.

FIG. 6 illustrates the change in amplitude over time of a movable unit in image stabilizing processing according to this embodiment.

### DETAILED DESCRIPTION

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a description will be given of embodiments according to the disclosure.

### FIRST EMBODIMENT

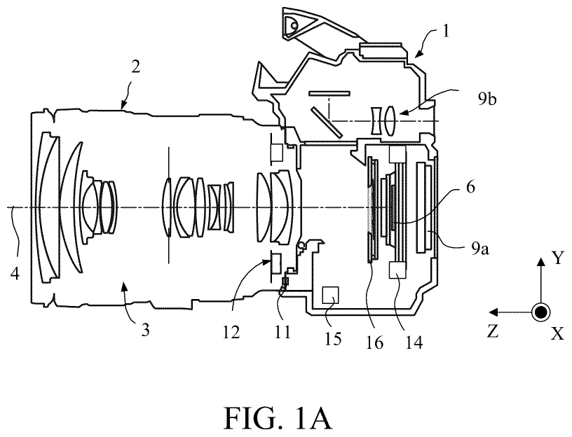

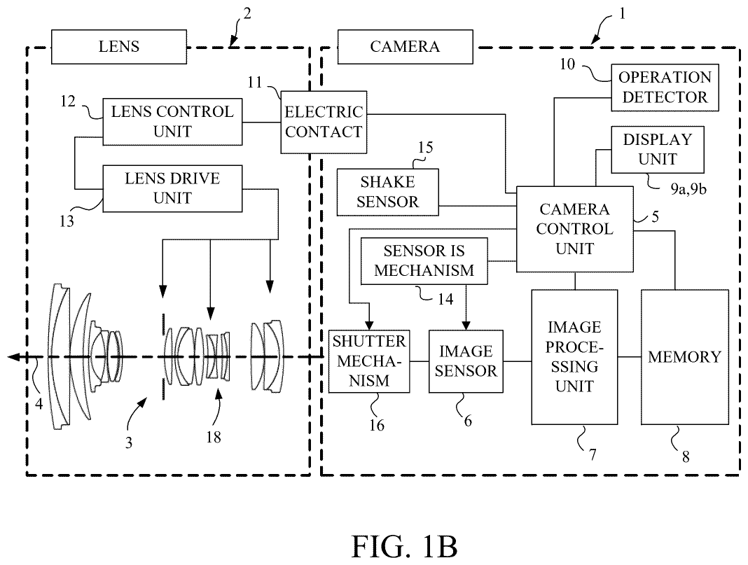

FIG. 1A illustrates a section of an imaging system including an image pickup apparatus 1 according to this embodiment and a lens apparatus 2 attachable to and detachable from the image pickup apparatus 1, and FIG. 1B illustrates the electrical configuration of the imaging system. Those elements in FIGS. 1A and 1B, which are corresponding elements, will be designated by the same reference numerals.

The lens apparatus 2 includes an imaging lens 3 that includes a plurality of lenses (optical elements) and an aperture stop (diaphragm). The imaging lens 3 includes a focus lens and a magnification-varying lens that move in a direction in which an optical axis 4 extends (optical axis direction). The lens apparatus 2 further includes a lens image-stabilization mechanism (lens IS mechanism) 18 that moves (shifts) a correction lens, which is a part of the imaging lens 3, in two directions that are orthogonal to the optical axis 4 and orthogonal to each other. The lens apparatus 2 further includes a lens driving unit 13 that drives the focus lens, the aperture stop, and the lens IS mechanism 18, and a lens control unit 12 that controls this.

The image pickup apparatus 1 includes a camera control unit 5, an image sensor 6, an image processing unit 7, a memory 8, a rear display (unit) 9a, an electronic viewfinder (EVF) 9b, an operation detector 10, and electrical contacts 11.

The image sensor 6 includes photoelectric conversion elements such as a CCD sensor or a CMOS sensor, and performs photoelectric conversion for (images or captures) an object image formed by the imaging lens 3. The image processing unit 7 generates an image (live-view image and captured image) based on an imaging signal obtained from the image sensor 6. The captured image data is recorded in the memory 8. The image sensor 6 and the image processing unit 7 can generate a still image and a moving image in a variety of formats, such as aspect ratio and resolution. They can also generate a high dynamic range (HDR) image, a noise-reduced image, etc., by combining a plurality of images acquired by multiple temporally consecutive imaging (or imaging operations).

The rear display 9a includes display elements such as an LCD, and displays a live-view image and various imaging information. The EVF 9b includes a display element such as an LCD and an eyepiece optical system, and the user can view a live-view image or the like displayed on the display element by peeping through the eyepiece optical system.

The operation detector 10 detects the user operation of a variety of operating members (shutter button, setting dial, etc.) provided on the image pickup apparatus 1, and outputs a detection signal to the camera control unit 5. The electrical contacts 11 provide an electrical connection with the lens apparatus 2. Thereby, power supply from the image pickup apparatus 1 to the lens apparatus 2 and communication between the image pickup apparatus 1 and the lens apparatus 2 can be provided.

The image pickup apparatus 1 further includes an image stabilizing mechanism 14, a shake sensor 15, and a shutter mechanism 16. The shake sensor 15 detects camera shake caused by hand shake or the like. The camera shake includes pan shake and tilt shake in two directions that are orthogonal to the optical axis 4 and orthogonal to each other, and roll shake around an axis parallel to the optical axis 4. The sensor IS mechanism 14 reduces (corrects) image blur by moving (shifting) the image sensor 6 in two directions orthogonal to the optical axis 4 and orthogonal to each other, and by moving (rolling) the image sensor 6 around an axis parallel to the optical axis 4. The shutter mechanism 16 controls the exposure time of the image sensor 6.

The camera control unit 5 is a computer such as a CPU, and corresponds to a control apparatus. The camera control unit 5 performs operations according to an operation signal from the operation detector 10, controls the sensor IS mechanism 14 based on camera shake detected by the shake sensor 15, and controls the shutter mechanism 16. The camera control unit 5 also performs autofocus (AF) and auto-exposure (AE) that sets an aperture value (F-number) and shutter time through the lens control unit 12 based on a focus detection signal and a luminance signal obtained from the image sensor 6. The camera control unit 5 also causes the lens control unit 12 to control the operation of the aperture stop and the lens IS mechanism 18.

Imaging processing performed by the camera control unit 5 will now be described. In a case where the user half-presses the shutter button provided to the image pickup apparatus 1, the camera control unit 5 detects this through the operation detector 10 and performs an imaging preparation operation including AF, AE, and opening of the shutter mechanism 16. During the imaging preparation operations (i.e., before imaging), the user performs aiming to determine a composition including an object to be imaged while viewing a live-view image displayed on the rear display 9a or EVF 9b. To facilitate aiming, the camera control unit 5 controls the sensor IS mechanism 14 based on the camera shake detected by the shake sensor 15.

Thereafter, in a case where the user fully presses the shutter button, the camera control unit 5 detects this through the operation detector 10 and performs imaging to open and close the shutter mechanism 16 at the set shutter time to expose the image sensor 6 and generate a captured image (still image). During exposure of the image sensor 6 (i.e., during imaging), the sensor IS mechanism 14 is also controlled to suppress shake of the object image. In a case where a predetermined time has elapsed after exposure is completed, the camera control unit 5 stops controlling the sensor IS mechanism 14.

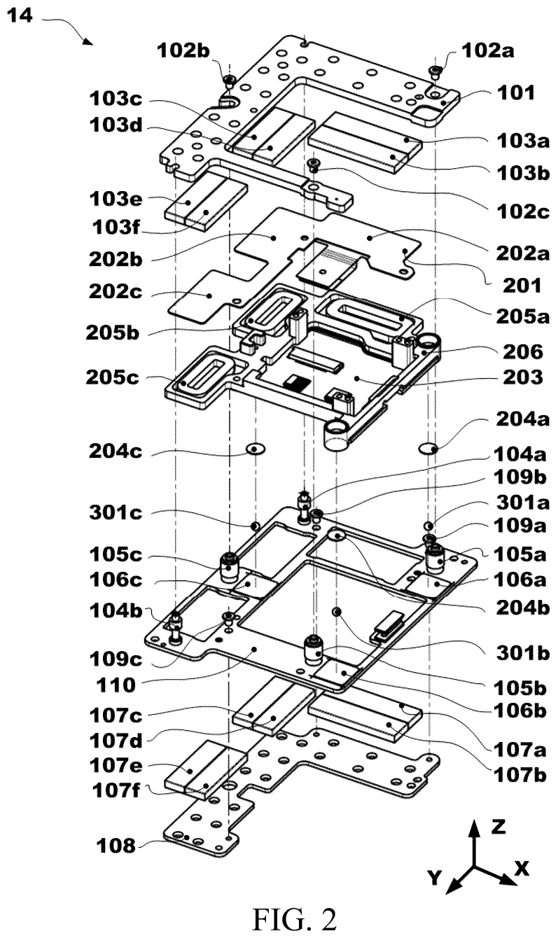

FIG. 2 illustrates the mechanical configuration of the sensor IS mechanism 14. The up and down direction in FIG. 2 is the optical axis direction. In FIG. 2, members that constitute a fixed unit that does not move will be given reference numbers in the 100s, and members that constitute a movable unit that moves relative to the fixed unit will be given reference numbers in the 200s.

Reference number 101 denotes an upper yoke. Reference numerals 102a, 102b, and 102c denote screws. Reference numerals 103a, 103b, 103c, 103d, 103e, and 103f denote upper magnets. Reference numerals 104a and 104b denote auxiliary spacers. Reference numerals 105a, 105b, and 105c denote main spacers, reference numerals 106a, 106b, and 106c denote fixed ball receiving plates. Reference numerals 107a, 107b, 107c, 107d, 107e, and 107f denote lower magnets. Reference numeral 108 denotes a lower yoke. Reference numerals 109a, 109b, and 109c denote screws. Reference numeral 110 denotes a base plate.

Reference numeral 201 denotes a flexible printed circuit (FPC). Reference numerals 202a, 202b, and 202c denote element attachment positions on the FPC 201. Reference numeral 203 denotes a movable printed circuit board (PCB). Reference numerals 204a, 204b, and 204c denote movable ball receivers. Reference numerals 205a, 205b, and 205c denote coils. Reference numeral 206 denotes a movable frame. Reference numerals 301a, 301b, and 301c denote balls.

A magnetic circuit (closed circuit) is formed by the upper yoke 101, upper magnets 103 to 103f, lower magnets 107a to 107f, and lower yoke 108. The upper magnets 103a to 103f are adhered to and fixed in a state where they are attracted to the upper yoke 101. Similarly, the lower magnets 107a to 107f are adhered to and fixed in a state where they are attracted to the lower yoke 108.

The upper magnets 103a to 103f and the lower magnets 107a to 107f are each magnetized in the optical axis direction, and adjacent magnets (e.g., upper magnets 103a and 103b) are magnetized in different directions. Opposing magnets (e.g., upper magnet 103a and lower magnet 107a) are magnetized in the same direction. This magnetization creates a high magnetic flux density in the optical axis direction between the upper yoke 101 and the lower yoke 108, generating a strong attraction force. Thus, the main spacers 105a to 105c and the auxiliary spacers 104a and 104b are configured to maintain a proper distance between the upper yoke 101 and the lower yoke 108. The proper distance is a distance that can secure a predetermined gap in a case where the coils 205a to 205c and the FPC 201 are placed between the upper magnets 103a to 103f and the lower magnets 107a to 107f.

The main spacers 105a to 105c have screw holes, and the upper yoke 101 is fixed to the main spacers 105a to 105c by the screws 102a to 102c inserted into these screw holes. Rubber is also placed on the bodies of the main spacers 105a to 105c, forming a mechanical end (stopper) for the movable unit.

The base plate 110 has openings at positions corresponding to the lower magnets 107a to 107f, and surfaces of the lower magnets 107a to 107f disposed on the coil side of the lower magnets 107a to 107f protrude from these openings. That is, the base plate 110 and the lower yoke 108 are fixed by the screws 109a to 109c, and the lower magnets 107a to 107f, which are thicker than the base plate 110, are fixed to the base plate 110 so that they protrude from the openings in the base plate 110.

The movable frame 206 is made of magnesium die-cast or aluminum die-cast, and is lightweight and highly rigid. The members that constitute the movable unit are fixed to the movable frame 206. Position detection elements are attached to the rear side (the surface not visible in FIG. 2) of the element attachment positions 202a to 202c on the FPC 201. The position detection elements can use Hall elements or the like that can detect the position of the movable unit using the magnetic circuit described above. The position detection elements are placed inside the windings of the coils 205a to 205c.

The image sensor 6 illustrated in FIG. 1A, the coils 205a to 205c, and the position detection elements are connected to the movable PCB 203, and they electrically communicate with the outside via the connector on the movable PCB 203.

The fixed ball receiving plates 106a to 106c are adhesively fixed to the base plate 110, and movable ball receiving plates 204a to 204c are adhesively fixed to movable frame 206. The fixed ball receiving plates 106a to 106c and the opposing movable ball receiving plates 204a to 204c hold balls 301a-301c rollably. As balls 301a to 301c roll, they guide the movable unit in a direction orthogonal to the optical axis 4 without tilting in the optical axis direction relative to the fixed unit.

In the above configuration, energizing the coils 205a to 205c generates an electromagnetic force (thrust) in the magnetic circuit according to Fleming's left-hand rule, allowing the movable unit to shift or roll. At this time, the shift position or roll position of the movable unit can be feedback-controlled using a signal from the position detection element. More specifically, the movable unit can be rolled by electrifying the coils 205a to 205c so that the signals of the position detection elements at the element attachment positions 202b and 202c are in reverse phase while keeping the signal of the position detection element at element attachment position 202a constant.

The sensor IS mechanism 14 illustrated in FIG. 2 uses magnets and coils as an actuator, and drives the movable unit at a low speed to correct low-frequency (e.g., 10 Hz or less) image blur caused by camera shake or the like with a large drive amount (amplitude) of the movable unit. On the other hand, using a piezoelectric element or another actuator that can drive the movable unit at high speed as the actuator can correct image blur at even higher frequencies. A drivable amount of the movable unit in correcting high-frequency image blur is smaller than a drivable amount of the movable unit in correcting low-frequency image blur. In other words, a correctable high-frequency image blur amount is smaller than a correctable low-frequency image blur amount.

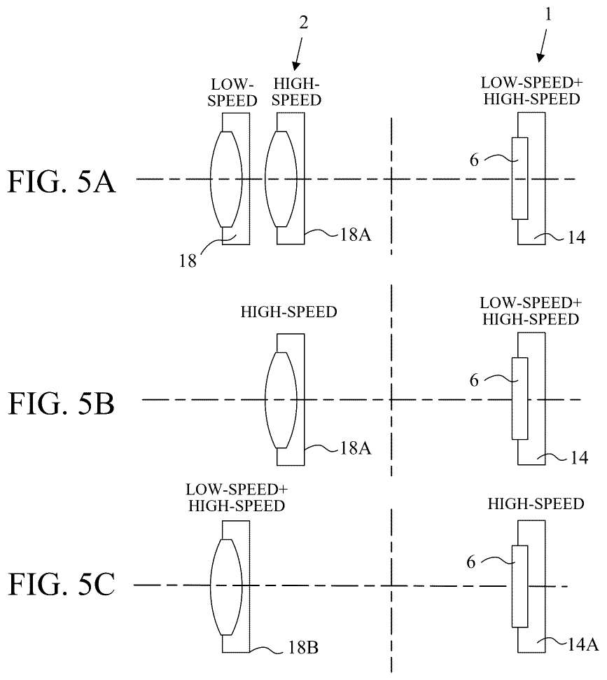

In the following description, the first image stabilizing operation that drives the movable unit at a low speed and with a large drive amount to correct (reduce) low-frequency (first frequency) image blur will be referred to as low-speed image stabilization, and the second image stabilizing operation that drives the movable unit at a high speed and with a small drive amount to correct image blur up to a higher frequency (second frequency) will be referred to as high-speed image stabilization. In the following description, the sensor IS mechanism 14 in the image pickup apparatus 1 is a low-speed and high-speed image stabilizing mechanism that can provide both the low-speed image stabilization and high-speed image stabilization, as illustrated in FIG. 5A.

As illustrated in FIG. 5A, the lens apparatus 2 may include a second lens IS mechanism 18A that performs high-speed image stabilization in addition to the (first) lens IS mechanism 18 that performs low-speed image stabilization. Thereby, low-speed image stabilization and high-speed image stabilization can be provided in each of the image pickup apparatus 1 and the lens apparatus 2.

In the lens apparatus 2, in a case where the first and second lens IS mechanisms 18 and 18A can sufficiently correct image blurs caused by pan and tilt shakes by driving a plurality of lenses (first and second optical elements), the sensor IS mechanism 14 may be configured to correct only roll shake.

In controlling the lens IS mechanism of the lens apparatus 2 and the sensor IS mechanism of the image pickup apparatus 1, the camera control unit 5 directly controls the sensor IS mechanism and indirectly controls the lens IS mechanism by sending a control command for the lens IS mechanism to the lens control unit 12. At this time, the lens control unit 12 may control the lens IS mechanism based on camera shake detected by a lens-side shake sensor provided in the lens apparatus 2, although not illustrated in FIG. 1B. The lens control unit 12 may have a function for controlling the image stabilizing mechanism of the camera control unit 5, or an external control apparatus other than the image pickup apparatus 1 and the lens apparatus 2 may have this function.

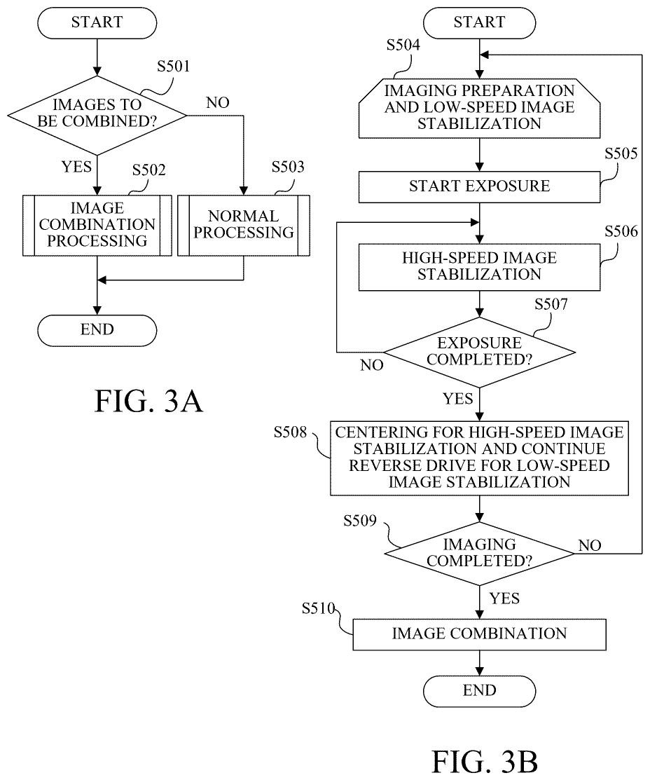

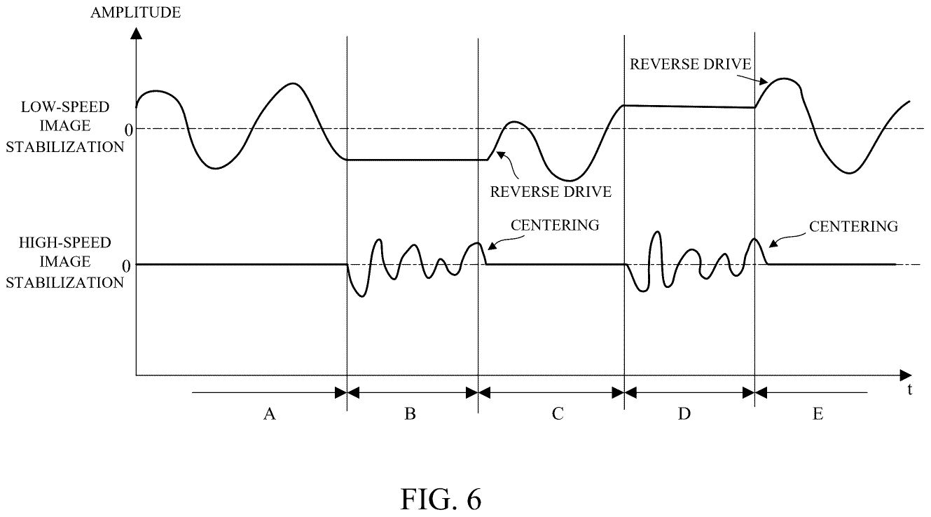

Next, image stabilizing processing (control method) executed by the camera control unit 5 according to a program will be described using the flowcharts illustrated in FIGS. 3A, 3B, and 3C. S stands for step. FIG. 6 illustrates the time change in the amplitude of the movable unit in low-speed image stabilization (upper part) and high-speed image stabilization (lower part) during image stabilizing processing. The horizontal axis represents time t, and the vertical axis represents an amplitude.

In S501 of FIG. 3A, the camera control unit 5 determines whether or not to perform image combination processing, which aligns and superimposes (i.e., combines) a plurality of (e.g., two) images acquired by multiple consecutive imaging (exposures) to obtain a combined image. More specifically, for example, it determines whether or not the execution of image combination processing has been selected by the user. In a case where image combination processing is to be performed, processing of S502 is performed, and in a case where image combination processing is not to be performed, processing of S503 is performed.

In S502, the camera control unit 5 performs image combination processing. Details of image combination IS will be described later using the flowchart in FIG. 3B.

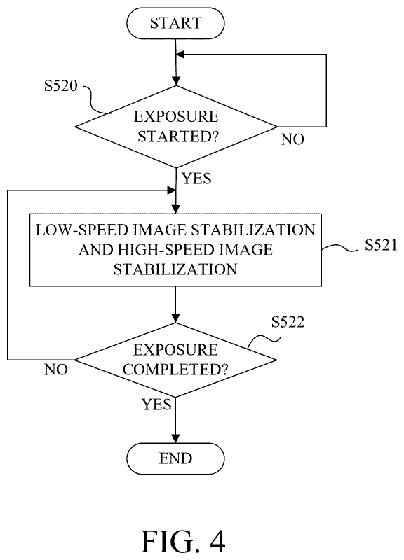

In S503, the camera control unit 5 performs normal processing. Details of normal processing will be described later using the flowchart in FIG. 4.

The image combination processing will now be described. In a case where the user half-presses the shutter button in S504 in FIG. 3B, the camera control unit 5 starts an imaging preparation operation. At the same time, the camera control unit 5 starts low-speed image stabilization (A in FIG. 6). The low-speed image stabilization at this time is performed by one or both of the sensor IS mechanism 14 and the first lens IS mechanism 18.

Next, when the user fully presses the shutter button in S505, the camera control unit 5 starts exposure. Then, high-speed image stabilization is performed in S506 (B in FIG. 6). The camera control unit 5 causes one or both of the sensor IS mechanism 14 and the second lens IS mechanism 18A to perform this high-speed image stabilization during exposure.

Next, in S507, the camera control unit 5 determines whether the exposure for the set shutter time has completed. In a case where the exposure has not been completed, the flow returns to S506 to continue the high-speed image stabilization. When the exposure is completed (i.e., after imaging), the process of S508 is performed.

In S508, the camera control unit 5 centers the movable unit of the high-speed image stabilizing mechanism (C in FIG. 6). At this time, the movable unit of the low-speed image stabilizing mechanism is driven so as to reduce the displacement of the object image caused by performing centering for the high-speed image stabilizing mechanism (i.e., in the opposite direction to centering), and is then driven so as to obtain the image stabilization effect due to the low-speed image stabilization. This centers the high-speed image stabilizing mechanism, and can maintain the image stabilization effect while securing the subsequent drivable amount of the high-speed image stabilizing mechanism. Centering refers to an operation of moving the position of the movable unit closer to the reference position in a case where the position of the movable unit shifts from the reference position, which is the center position of the drive range of the movable unit. FIG. 6 illustrates the reference position as a position of an amplitude of 0. The drivable range of the movable unit may be set for control purposes, and the reference position may be variable, for example, according to the center of the lens optical axis of the lens apparatus 2. That is, the controls in B and C in FIG. 6 can be rephrased as follows. The second optical element (the movable unit of the high-speed image stabilizing mechanism) is moved from the reference position so as to reduce object image blur during imaging. After imaging, the second optical element is moved closer to the reference position, and the first optical element (the movable unit of the low-speed image stabilizing mechanism) is moved so as to reduce the movement of the object image caused by moving the second optical element closer to the reference position.

Next, in S509, the camera control unit 5 determines whether or not imaging of the plurality of images has been completed as expected. In a case where imaging of the plurality of images has not been completed, the process from S504 is repeated (D and E in FIG. 6). In this case, low-speed image stabilization is performed between the previous exposure and the next exposure (i.e., before the next exposure). In a case where imaging of the plurality of images has been completed, the process of S510 is performed.

In S510, the camera control unit 5 performs processing of aligning and combining the plurality of images. For example, a correlation value between a first image and a second image as the plurality of images is calculated, or feature points are detected by template matching or the like, and the first image and the second image are aligned using the obtained correlation value or feature points and then superimposed. Thereby, a combined image in which image blur has been satisfactorily corrected is generated. Then, the image combination processing is completed.

The normal processing will be described. Here, an example of normal image stabilization will be described, but other normal image stabilization may be performed.

In S520 in FIG. 4, the camera control unit 5 determines whether exposure has started. In a case where exposure has not started, the determination of S520 is repeated. In a case where exposure has started, the processing of S521 is performed.

In S521, the camera control unit 5 corrects image blur by using the low-speed image stabilizing mechanism and the high-speed image stabilizing mechanism, that is, by switching between low-speed image stabilization and high-speed image stabilization according to the camera shake.

Next, in S522, the camera control unit 5 determines whether exposure has been completed, and if not, continues image stabilization in S521. In a case where exposure has been completed, normal processing ends.

FIG. 5A illustrates a case where the lens apparatus 2 is provided with a low-speed image stabilizing mechanism (18) and a high-speed image stabilizing mechanism (18A), but as illustrated in FIG. 5B, the lens apparatus 2 may be provided with only a high-speed image stabilizing mechanism (18A). As illustrated in FIG. 5C, the image pickup apparatus 1 may be provided with only a high-speed image stabilizing mechanism (14A), or the lens apparatus 2 may be provided with a low-speed and high-speed image stabilizing mechanism (18B). Thus, as long as the imaging system includes at least one low-speed image stabilizing mechanism and at least one high-speed image stabilizing mechanism, the image stabilizing processing illustrated in FIGS. 3A, 3B, and 4 can be performed.

A description will be given of an usage example of low-speed image stabilization and high-speed image stabilization in a case where both the low-speed image stabilization and the high-speed image stabilization are available in each of the image pickup apparatus 1 and the lens apparatus 2.

First, during the imaging preparation operation period before exposure, the lens apparatus 2 is caused to perform low-speed image stabilization for pan shake and tilt shake, and during exposure, the lens apparatus 2 is caused to perform high-speed image stabilization for pan shake and tilt shake, and the image pickup apparatus 1 is caused to perform high-speed image stabilization for roll shake. This is because the lens IS mechanism cannot correct image blur caused by roll shake. The image pickup apparatus 1 may be caused to perform low-speed image stabilization for roll shake before exposure.

Between the end of exposure and the next exposure, the lens apparatus 2 is caused to perform centering for high-speed image stabilization, and also perform low-speed image stabilization. Centering for high-speed image stabilization and low-speed image stabilization at this time are as discussed in S508 of FIG. 3B. In addition, the image pickup apparatus 1 may be caused to perform low-speed image stabilization for roll shake between the end of an exposure and the next exposure.

In a case where the lens apparatus 2 is capable of low-speed image stabilization and high-speed image stabilization and the image pickup apparatus 1 is capable of only low-speed image stabilization, high-speed image stabilization for roll shake during exposure is not performed. In a case where the lens apparatus 2 is capable of low-speed image stabilization and high-speed image stabilization and the image pickup apparatus 1 has no image stabilizing mechanism, image stabilization for roll shake is not performed. In a case where the image pickup apparatus 1 is capable of low-speed image stabilization and high-speed image stabilization and the lens apparatus has no image stabilizing mechanism, the image pickup apparatus 1 performs low-speed image stabilization and high-speed image stabilization for pan shake, tilt shake, and roll shake.

A description will be given of the reason for performing high-speed image stabilization during exposure in this embodiment. Image blur during exposure cannot be corrected by image combination IS. Thus, image blur during exposure remains in the finally combined image. Furthermore, since high-frequency vibrations that cause image blur are often included during exposure compared to before exposure, it is necessary to correct image blur caused by high-frequency vibrations using high-speed image stabilization. High-frequency vibrations can be caused by movement of components of the image pickup apparatus 1, such as the opening and closing of the shutter blades in the shutter mechanism 16, or by the user's hand shake.

Thus, this embodiment performs high-speed image stabilization during exposure for each image to be combined, combines a plurality of images in which image blur has been corrected, and consequently provide a combined image with less image blur.

A description will be given of the reason for performing centering for high-speed image stabilization in a case where exposure ends in this embodiment. In the high-speed image stabilizing mechanism, a drivable amount of the movable unit (the maximum drive amount determined by the mechanical end or control end) is set smaller than that in the low-speed image stabilizing mechanism. Thus, in a case where high-speed image stabilization is performed in the next exposure while the movable unit of the high-speed image stabilizing mechanism remains in a state where it has moved in the pan or tilt direction from its drive center, the drivable amount of the movable unit may run short and good high-speed image stabilization may not be performed. To prevent this problem, centering for high-speed image stabilization is performed at the exposure end.

A description will be given of the reason why low-speed image stabilization is performed in the opposite direction to centering for high-speed image stabilization in this embodiment. Simply performing centering for high-speed image stabilization may result in a large shift between an image obtained in the first exposure and an image obtained in the next exposure. Thus, performing low-speed image stabilization in the opposite direction to centering for high-speed image stabilization can reduce the shift between these images. Thereby, an area to be removed from each image to be aligned and combined, which is an area unnecessary for combination, can be reduced.

Performing low-speed image stabilization until the next exposure can reduce the image shift. This configuration can also reduce the area to be removed from each image to be aligned and combined.

The image combination IS described in the above embodiments may be used in generating one frame image by combining a plurality of subframe images in moving image capturing, or in aligning and combining a plurality of still images to generate a combined image equivalent to a still image obtained by long exposure. Low-speed image stabilization before exposure and high-speed image stabilization during exposure may be performed in normal imaging that generates a single image in single imaging.

In the above embodiment, the imaging system includes a lens interchangeable type image pickup apparatus and a lens apparatus, but the imaging system may include a lens integrated type image pickup apparatus and may perform low-speed image stabilization and high-speed image stabilization by driving a lens of an optical system or an image sensor in the image pickup apparatus.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This embodiment can reduce image blur during imaging.

This application claims the benefit of Japanese Patent Application No. 2024-128744, which was filed on Aug. 5, 2024, and which is hereby incorporated by reference herein in its entirety.

What is claimed is:

1. A control apparatus configured to control a first image stabilizing operation for reducing a shake at a first frequency of an object image to be imaged and a second image stabilizing operation for reducing a shake at a second frequency higher than the first frequency of the object image, the control apparatus comprising:
one or more memories storing instructions; and
one or more processors that, upon execution of the instructions, operate to:
cause the first image stabilizing operation to be performed before imaging, and
cause the second image stabilizing operation to be performed during imaging.

2. The control apparatus according to claim 1, wherein the one or more processors operate to:
cause centering for the second image stabilizing operation to be performed after imaging, and
cause the first image stabilizing operation to be performed so as to reduce displacement of the object image caused by the centering.

3. The control apparatus according to claim 1, wherein at least one of an optical element included in an optical system configured to form the object image and an image sensor that images the object image is driven in the first image stabilizing operation and the second image stabilizing operation.

4. The control apparatus according to claim 3, wherein in the first image stabilizing operation and the second image stabilizing operation, the optical element is driven to reduce the shake in a direction orthogonal to an optical axis of the optical system, and the image sensor is driven to reduce the shake around an axis parallel to the optical axis.

5. The control apparatus according to claim 3, wherein the one or more processors operate to:
control the first image stabilizing operation for driving a first optical element included in the optical system configured to form the object image,
control the second image stabilizing operation for driving the first optical element or a second optical element included in the optical system,
control the first image stabilizing operation for driving the image sensor, and
control the second image stabilizing operation for driving the image sensor.

6. The control apparatus according to claim 1, wherein in a case where a combined image is generated by aligning and combining a plurality of images acquired by multiple imaging, the one or more processors operate to:
cause the first image stabilizing operation to be performed before each of the multiple imaging, and
cause the second image stabilizing operation to be performed during each of the multiple imaging.

7. The control apparatus according to claim 5, wherein after each of multiple imaging, the one or more processors operate to:
perform centering for the second image stabilizing operation,
perform the first image stabilizing operation so as to reduce displacement of the object image caused by the centering, and
performs the first image stabilizing operation until next imaging.

8. An image pickup apparatus comprising:
the control apparatus according to claim 1; and
an image sensor configured to image the object image.

9. The image pickup apparatus according to claim 8, wherein the control apparatus causes the first image stabilizing operation to be performed to drive the image sensor, and the second image stabilizing operation to be performed to drive the image sensor.

10. A lens apparatus attachable to and detachable from the image pickup apparatus according to claim 9, the lens apparatus comprising:
an optical system configured to form the object image;
one or more memories storing instructions; and
one or more processors that, upon execution of the instructions, operate to:
perform the first image stabilizing operation to drive a first optical element included in the optical system, and
perform the second image stabilizing operation to drive the first optical element or a second optical element included in the optical system.

11. A control apparatus configured to control a first image stabilizing unit configured to reduce a shake of an object image to be imaged, by moving a first optical element, and a second image stabilizing unit configured to reduce a shake at a frequency higher than that of the first image stabilizing unit of the object image by moving a second optical element, the control apparatus comprising:
one or more memories storing instructions; and
one or more processors that, upon execution of the instructions, operate to:
move the second optical element from a reference position using the first image stabilizing unit and the second image stabilizing unit so as to reduce the shake of the object image during imaging, and
move, using the first image stabilizing unit and the second image stabilizing unit after imaging, the second optical element closer to the reference position and the first optical element so as to reduce displacement of the object image caused by moving the second optical element closer to the reference position.

12. A control method configured to control a first image stabilizing operation for reducing a shake at a first frequency of an object image to be imaged and a second image stabilizing operation for reducing a shake at a second frequency higher than the first frequency of the object image, the control method comprising:
causing the first image stabilizing operation to be performed before imaging; and
causing the second image stabilizing operation to be performed during imaging.

13. A non-transitory computer-readable storage medium storing a program that causes a computer to execute the control method according to claim 12.
